(19) United States
(12) Patent Application Publication
(10) Pub. No.: US 2009/0010305 A1
(43) Pub. Date: Jan. 8, 2009

(54) Temperature Indicator

(75) Inventors: Eduard Johannes Meijer, Eindhoven (NL); Ralph Kurt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,908

(22) PCT Filed: Oct. 6, 2005
(86) PCT No.: PCT/IB05/53282

§ 371 Date: Apr. 9, 2007

(30) Foreign Application Priority Data
Oct. 15, 2004 (EP) 04105080.8

(51) Int. Cl. G01K 11/00

(52) U.S. Cl. 374/161; 374/E11.001

(57) ABSTRACT

A temperature indicator (1) for indicating a high temperature at a surface (13) comprises a light-emitting electro-chemical cell (4) having a first electrode (8), a second electrode (9) and a light-emitting layer (10) being sandwiched between the two electrodes (8, 9). The light-emitting layer (10) comprises a matrix and ions being movable in the matrix, the mobility of said ions in said matrix being temperature dependent. A power source (5) is adapted for driving the light-emitting cell (4) with an AC voltage. The frequency of the AC voltage is tuned in such a way that, above a certain temperature level, the ions move fast enough in the matrix to provide a sufficient charge gradient in the light-emitting electrochemical cell (4) for the light-emitting electrochemical cell (4) to emit light before the AC power source (5) shifts the polarity of the voltage.

### FIELD OF THE INVENTION

The present invention relates to a temperature indicator adapted to be provided on a surface for providing a visual indication of the temperature of the surface.

The present invention also relates to a method of forming a temperature indicator adapted to be provided on a surface for providing a visual indication of the temperature of the surface.

### BACKGROUND OF THE INVENTION

In many appliances hot temperatures are involved during use. Examples of such appliances are irons, water cookers, hot plates, oven windows, frying pans, toasters, waffle irons etc. In order to avoid injuries, such as burn injuries, to persons using such appliances there is a need to have an indicator indicating to the person using the appliance that it is hot and that care must be taken. Such indication of a high temperature is usually done by having a temperature sensor, a control unit coupled to the sensor and a warning lamp, which is lit by the control unit when the sensor registers a high temperature. One example of such a system may be found in U.S. Pat. No. 6,396,027 B1 describing an iron having three indicator members that are controlled by a controller receiving signals from a temperature sensing unit. A disadvantage with the type of temperature indicator described in U.S. Pat. No. 6,396,027 B1 is that it is complicated and requires the proper cooperation between several components in order to perform accurately in warning a user for high temperatures. A broken lamp may, as an example, give the user the incorrect impression that the iron is cold when it in reality is hot. Furthermore, a temperature indicator of this type does not give any information as regards which part of the surface that is hot, if it is the entire surface or only a part of it.

### SUMMARY OF THE INVENTION

An object of the present invention is to provide a temperature indicator which accurately and at low cost provides a safe indication of whether a surface is hot or not.

This object is achieved by a temperature indicator adapted to be provided on a surface for providing a visual indication of the temperature of the surface, the temperature indicator comprising a light-emitting electrochemical cell having a first electrode, a second electrode and a light-emitting layer being positioned between the two electrodes and comprising a matrix and ions being movable in the matrix, the mobility of said ions in said matrix being temperature dependent, the temperature indicator further comprising a power source adapted for driving the light-emitting electrochemical cell with an AC voltage, the frequency of which is tuned in such a way that the light-emitting electrochemical cell emits light when the temperature of the surface exceeds a certain level.

An advantage of this temperature indicator is that it provides an accurate indication of a hot surface since the temperature dependent light emission characteristics is an intrinsic property of the light-emitting electrochemical cell itself when driven with an AC voltage of a certain frequency. Since the temperature indicator is adapted to be placed onto a potentially hot surface there is no risk that the temperature indicated is not the relevant temperature of that surface. The light-emitting electrochemical cell has no wear parts, such as a light bulb filament, and thus the risk of failure is minimal. In relation to the prior art, which requires a sensor, a control unit, a power source and a warning lamp, the number of parts is reduced since, in the temperature indicator according to the invention, the light-emitting electrochemical cell will function both as sensor and warning lamp, and in a way also as a control system. This reduces the production cost and also reduces the risk that the temperature indicator fails to indicate a high temperature. In addition to providing the control of at which temperature the light emission should start the AC voltage also provides the advantage of preventing the ionic charge distribution from being more or less permanently “frozen” which may occur with a DC voltage as is described by G. Yu et al., Adv. Mater. 10, 385, 1998. Yet another advantage of the temperature indicator according to the invention is that it does not only indicate whether the surface is hot but also which part of if it that is hot. If a temperature indicator according to the invention is attached to the entire surface of e.g. the sole of an iron light emission will occur only in those parts of the surface where the temperature is high enough to make the light-emitting layer emit light according to the principles of the light-emitting cell.

An advantage with the measure according to claim 2 is that it provides for a temperature indicator with a large area for covering a part of or the whole of the surface that is potentially hot, and a high visibility since light is emitted through at least one of the electrodes.

An advantage with the measure according to claim 3 is that the light emission by the light-emitting electrochemical cell provides a very accurate correlation to the temperature at the surface which is to be monitored by the temperature indicator. An advantage with the measure according to claim 4 is that it provides a light-emitting electrochemical cell which is transparent and which could be laminated on windows and other objects in which transparency is necessary.

An advantage of the measure according to claim 5 is that organic materials, which may be polymeric materials, but also organic molecules of substantially smaller size, are suitable for providing the desired temperature dependent light emission of the light-emitting electrochemical cell since the mobility of ions in organic materials tends to be highly temperature dependent in the desired temperature range.

An advantage with the measure according to claim 6 is that polymeric materials provide suitable solid matrixes in which ions are mobile and in which the temperature dependence of the mobility of the ions is strong. The polymeric materials are often transparent and in many cases resist temperatures of up to 130° C. and above. The fact that the polymeric materials are solid, still permitting the mobility of ions, makes manufacturing and handling of the temperature indicator easier.

An advantage with the measure according to claim 7 is that the frequency modulator enables the user to tune the temperature indicator to start indicating at a desired temperature, i.e. the user may himself adjust the threshold temperature at which light emission should begin to a desired temperature by adjusting the AC voltage frequency. This provides for a temperature indicator useful not only in household appliance applications but also in industrial applications where a large area light emitting temperature indicator may be used as an accurate visual indicator for process problems.

An advantage with the measure according to claim 8 is that it provides for the indication of hot surface to start at, or preferably lower than, a temperature at which burn damage to human skin is likely.

An advantage with the measure according to claim 9 is that a total thickness of maximum 1 mm provides for a thin temperature indicator which is easy to attach to a hot surface, such as the sole of an iron, without causing unwanted insulation of the hot surface.

An advantage of the measure according to claim 10 is that such a temperature indicator would not only indicate that a surface is hot, but would additionally indicate which parts of the surface are the hottest and which parts are cold and could be touched. Thus the risk that a user unintentionally touches a hot part of the surface is minimized.

An advantage of the measure according to claim 11 is that thermal contacts extending through the light-emitting electrochemical cell provides for improved heat transfer through the cell and decreases any unwanted insulating effects.

Another object of the present invention is to provide a cheap method of forming an accurate temperature indicator.

This object is achieved by a method of forming a temperature indicator adapted to be provided on a surface for providing a visual indication of the temperature of the surface, comprising the steps of:

providing a light-emitting electrochemical cell having a first electrode, a second electrode and a light-emitting layer being positioned between the two electrodes and comprising a matrix and ions being movable in the matrix, the mobility of said ions in said matrix being temperature dependent,

connecting an AC power source to the electrodes of the light-emitting cell, and

tuning the frequency of the AC voltage such that the electrochemical cell emits light when heated above a certain temperature.

These and other aspects of the invention will be apparent from and elucidated with reference to the embodiments described hereinafter.

### BRIEF DESCRIPTION OF THE DRAWINGS

The invention will now be described in more detail with reference to the appended drawings in which:

FIG. 1 is a three dimensional view and shows schematically a temperature indicator provided on the entire sole of an iron.

FIG. 2 is a partial section view and shows the temperature indicator along section II-II of FIG. 1.

FIG. 3a is an enlarged section view and shows the portion III of FIG. 2 at a first occasion and at a temperature of the sole of 25° C.

FIG. 3b is an enlarged section view and shows the view of FIG. 3a at a second occasion at a temperature of the sole of 25° C.

FIG. 3c is an enlarged section view and shows the view of FIG. 3a at a third occasion at a temperature of the sole of 25° C.

FIG. 3d is an enlarged section view and shows the view of FIG. 3a at a fourth occasion at a temperature of the sole of 25° C.

FIG. 4a is an enlarged section view and shows the portion III of FIG. 2 at a first occasion and at a temperature of the sole of 90° C.

FIG. 4b is an enlarged section view and shows the view of FIG. 4a at a second occasion at a temperature of the sole of 90° C.

FIG. 4c is an enlarged section view and shows the view of FIG. 4a at third occasion at a temperature of the sole of 90° C.

FIG. 4d is an enlarged section view and shows the view of FIG. 4a at a fourth occasion at a temperature of the sole of 90° C.

FIG. 5 is a diagram and indicates the light emission from the temperature indicator at different temperatures.

FIG. 6 is a vertical section view and shows schematically a temperature indicator according to a second embodiment provided on an oven door.

FIG. 7 is a top view and shows a light-emitting electrochemical cell of another embodiment of a temperature indicator according to the invention.

FIG. 8 is a cross section and shows the light-emitting electrochemical cell of FIG. 7 along the line VIII-VIII.

FIG. 9 is a top view and shows a light-emitting electrochemical cell of yet another embodiment of a temperature indicator according to the invention.

### DESCRIPTION OF PREFERRED EMBODIMENTS

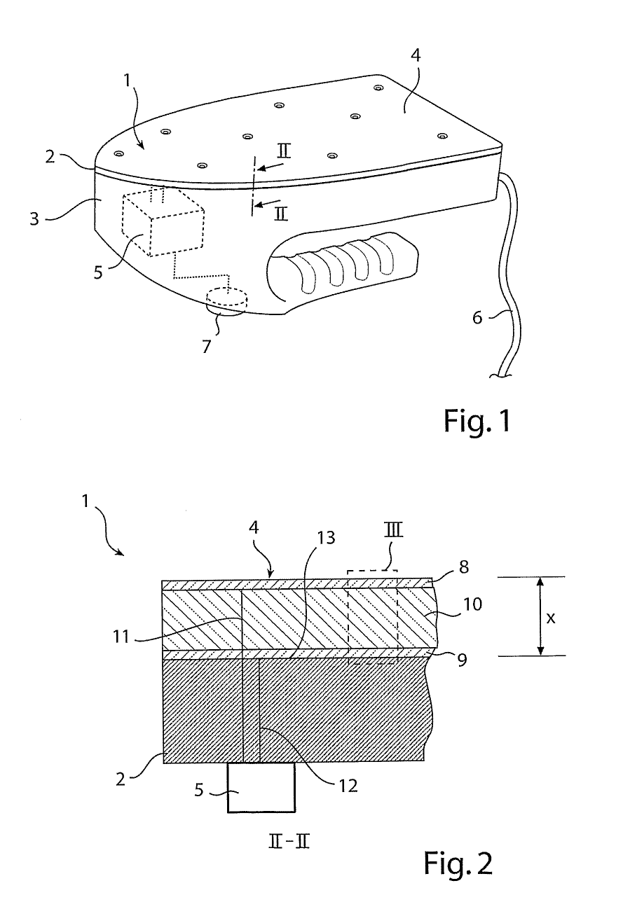

FIG. 1 shows schematically a temperature indicator 1 according to a first embodiment of the invention. The temperature indicator 1 covers the entire sole 2 of an iron 3. The temperature indicator 1 comprises a light-emitting electrochemical cell 4 and an AC power source 5 adapted to drive the light-emitting electrochemical cell 4 with a low frequency AC voltage. The AC power source 5 is connected to the main electricity system (not shown in FIG. 1) of the iron 3 and provides the light-emitting electrochemical cell 4 with an AC voltage all the time the electrical cable 6 of the iron 3 is connected to a power supply. An AC voltage frequency modulator 7 could optionally be included in the temperature indicator 1 in order to enable fine tuning of the temperature at which a light emission should start, as will be explained below.

FIG. 2 is a cross section showing the light-emitting electrochemical cell 4 having the shape of a thin laminate provided on the sole 2. The light-emitting electrochemical cell 4 comprises a first electrode 8, a second electrode 9 and a light-emitting layer 10 sandwiched between the electrodes 8, 9. The AC power source 5 provides the two electrodes 8, 9 with voltage via a first contact 11 and a second contact 12 respectively. The total thickness x of the laminate is about 0.5 mm of which the thickness of the light-emitting layer 10 is typically 1000 Å to 0.2 mm.

The first electrode 8 is made from an at least partly transparent electrode material, such as indium tin oxide (ITO). Other examples of alternative transparent electrode materials could be found in U.S. Pat. No. 5,682,043 (Pei et al).

The second electrode 9 is made from an electrode material which is not necessarily transparent but which is good at conducting heat from the surface 13 of the sole 2 to the light-emitting layer 10, and further through the first electrode 8 and to a garment or other object which is to be ironed. Examples of such electrode materials include metals such as aluminium, silver, platinum and nickel. Examples of other alternative electrode materials could be found in, for example, the above mentioned U.S. Pat. No. 5,682,043. Of course the second electrode 9 could also be made of a transparent or semi-transparent electrode material.

The light-emitting layer 10 comprises a semiconducting matrix and ions which are movable in the matrix, the mobility of the ions in the matrix being temperature dependent. The matrix is preferably a semiconducting polymeric material, such as a conjugated polymer or a co-polymer which contains segments of p-conjugated moieties. Examples of suitable semiconducting polymeric materials can be found in the above mentioned U.S. Pat. No. 5,682,043. The matrix could, as alternative, be made of another type of organic material, such as an organic material having substantially smaller molecular weight than the polymeric materials. The ions could be provided by salts comprising a cation, such as sodium ions, and an anion, such as chlorine ions. As an alternative the ions could be provided by a polymer electrolyte. Different types of ions suitable for a light-emitting electrochemical cell could be found, i.a., in the above mentioned US patent. Further, transition metal complexes, such as ruthenium tris-bipyridine, [Ru(bpy)₃]²⁺, combined with a suitable counter ion may be used as is described by P. McCord and A. J. Bard, J. Electronal. Chem., 318, 91, 1991. The ruthenium tris-bipyridine, [Ru(bpy)₃]²⁺, complex results in the emission of orange-red light, which may be very suitable in many applications were a visual warning of high temperature is desired.

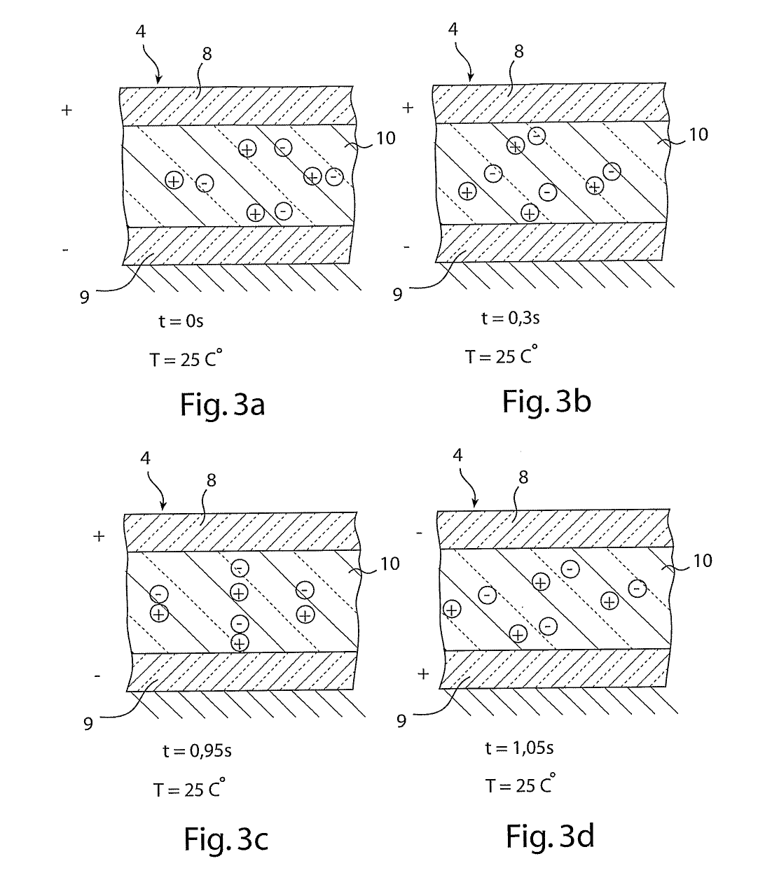

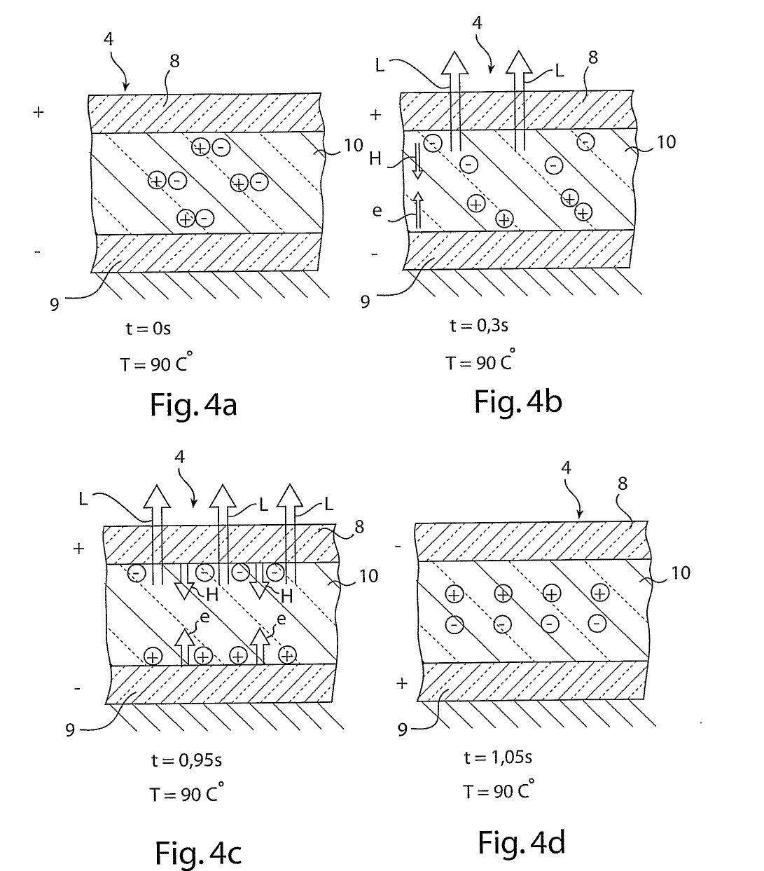

The practical operation, at two different temperatures, of the temperature indicator 1 will now be described in more detail with reference to FIG. 3a to 3d and FIG. 4a to 4d respectively. In the example given the frequency of the AC voltage is constant at 1 Hz, i.e. the polarity of the voltage is alternated once per second.

In the light-emitting electrochemical cell 4, the basic principle of which is per se known from Q. B. Pei et al, Science 269, 1086, 1995, J. Gao, G. Yu, A. J. Heeger, Appl. Phys. Lett. 71, 1293, 1997 and other documents, a voltage is applied between the two electrodes 8, 9. In the example described with reference to FIG. 3a to 3d the temperature at the surface 13 of the sole 2 is 25° C.

FIG. 3a indicates the situation at the exact moment the power is switched on. The AC power source provides the first electrode 8 with positive charge, making it the anode, and the second electrode 9 with negative charge, making it the cathode. The negative ions, represented by (−), and the positive ions, represented by (+), are at this moment still paired with each other. Due to the semiconducting properties of the light-emitting layer 10 no holes are injected from the first electrode 8, the anode, and no electrons are injected from the second electrode 9, the cathode.

FIG. 3b indicates the situation 0.3 s after switching on the voltage. As is clear the negative ions are moving, slowly, towards the first electrode 8, the anode, and the positive ions are moving, also slowly, towards the second electrode 9, the cathode. FIG. 3c indicates the situation 0.95 s after switching on the voltage, i.e. just before the polarity of the AC voltage is to be switched. As can be seen the negative ions have traveled a distance towards the first electrode 8, the anode, but there is no real accumulation of negative ions at the anode and thus no holes are injected into the light-emitting layer 10. Correspondingly there is no accumulation of positive ions at second electrode 9, the cathode, and thus no electrons will be injected either. In the absence of holes and electrons injected there will be no emission of light.

FIG. 3d indicates the situation 1.05 s after switching on the voltage, i.e. just after the polarity has been switched. The negative ions have begun a, slow, travel towards the second electrode 9, now being the anode, and the positive ions have begun a, slow, travel towards the first electrode 8, now being the cathode. As is illustrated in FIG. 3a to 3d the mobility of the ions, which is a diffusion limited process, in the matrix at 25° C. is so slow that no sufficient accumulation of negative ions and positive ions at the anode and at the cathode, respectively, is obtained before the AC power source switches the polarity of the voltage. Consequently no light is emitted at a temperature of 25° C.

In the example described with reference to FIG. 4a to 4d the temperature at the surface 13 of the sole 2 is 90° C.

FIG. 4a indicates the situation at the exact moment the power is switched on. The AC power source provides the first electrode 8 with positive charge, making it the anode, and the second electrode 9 with negative charge, making it the cathode. The negative ions, represented by (−), and the positive ions, represented by (+), are at this moment still paired with each other.

FIG. 4b indicates the situation 0.3 s after switching on the voltage. Due to the high mobility of the ions in the matrix at this increased temperature there is already at this occasion a rather large accumulation of negative ions at the first electrode 8, the anode, and of positive ions at the second electrode 9, the cathode. Due to the accumulation of ions, forming large ion density gradients at the electrodes, holes H are injected at the anode and electrons e are injected at the cathode. In the light-emitting layer 10 the holes H and electrons e recombine under emission of light, represented by arrows, L, in FIG. 4b.

FIG. 4c indicates the situation 0.95 s after switching on the voltage, i.e. just before the polarity of the AC voltage is to be switched. As can be seen there is a large accumulation of negative ions at the first electrode 8, the anode, and a large accumulation of positive ions at the second electrode 9, the cathode. The large ion gradients thereby formed at the respective electrodes 8, 9 provides for efficient injection of holes H and electrons e, respectively, and thus much light L is emitted by the electrochemical cell 4.

FIG. 4d indicates the situation 1.05 s after switching on the voltage, i.e. just after the polarity has been switched. The negative ions have begun a quick travel towards the second electrode 9, now being the anode, and the positive ions have begun a quick travel towards the first electrode 8, now being the cathode. When a sufficient accumulation of negative ions has been obtained at the second electrode 9, the anode, and a sufficient accumulation of positive ions has been obtained at the first electrode 8, the cathode, light emission will start again. Thus the light-emitting electrochemical cell will emit light both in forward and in backward operation. As is illustrated in FIG. 4a to 4d the mobility of the ions in the matrix at 90° C. is so quick that a sufficient accumulation of negative ions and positive ions at the anode and the cathode respectively is obtained soon after the AC power source has switched the polarity of the voltage. Consequently a flashing light is emitted by the temperature indicator 1 at a temperature at the surface 13 of 90° C. thereby warning the user of the iron 3 that the sole 2 is hot and that care should be taken not to touch the sole 2.

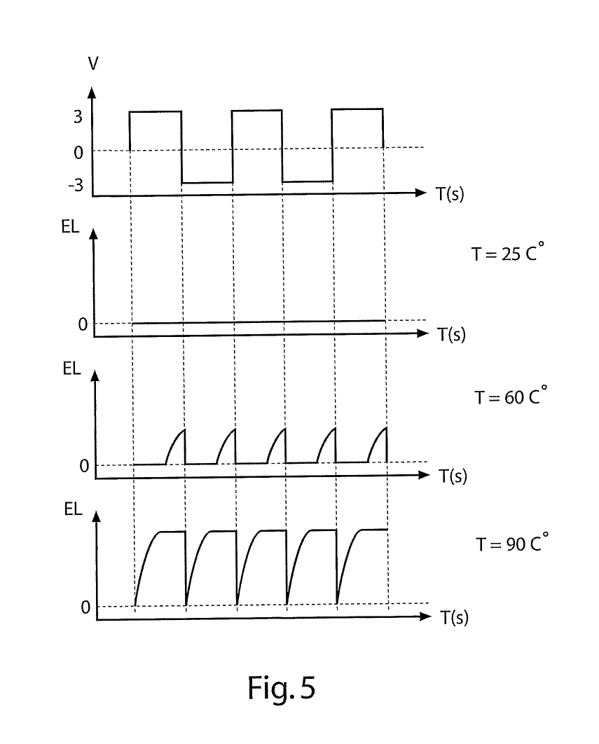

FIG. 5 indicates the electro-luminescence EL of the light-emitting electrochemical cell at different temperatures. The AC power source provides the light-emitting electrochemical cell with a voltage V of +/−3 V and shifts the polarity at a constant frequency of 1 Hz. At 25° C. the mobility of the ions in the matrix is too slow to provide a sufficient accumulation of ions at the respective electrode and thereby no light is emitted. At 60° C. the ions move rather fast in the matrix and thus light emission starts about 0.5 s after the polarity has been switched. The light emission continues, with an increasing intensity, for about 0.5 s until the polarity is switched again. At 90° C. the ions move so fast that a sufficient accumulation of ions is obtained almost directly after switching the polarity of the voltage. As is indicated in FIG. 5 the temperature indicator provides, at 60° C., a flashing light in which a dark period of 0.5 s is followed by 0.5 s of light emission. This flashing behaviour is easily observed by the user and reduces the risk that a warning of high temperature is missed. At higher temperatures, such as 90° C., the dark period is almost wiped out providing only a very short, initial period with somewhat lower light intensity. The temperature indicator does thus not only indicate that a surface is hot but also provides additional information on the actual temperature of the surface.

The frequency of the AC power source is tuned in such a way that with the thickness of the light-emitting layer, the type of matrix and the ions in question, light emission is obtained when the temperature exceeds a desired level, i.e. the threshold temperature. If, for example, it would be desired that light emission would start only at temperatures of 70° C. and higher, i.e. the threshold temperature is 70° C., the frequency of the AC power source could be increased from 1 Hz to for example 3 Hz. In such a case the accumulation of ions at 60° C. would not be sufficient for light emission. As alternative to increasing the frequency it is also possible to make the light-emitting layer thicker, exchange the matrix material for one in which the ions move slower and/or exchange the ions for a type which have lower mobility. Thus there are several ways to provide a temperature indicator, which provides light emission over a desired threshold temperature.

In the case the surface 13 of the sole 2 does not have an even temperature all over said surface 13 the light emission of the light-emitting electrochemical cell 4 will vary over the area. Thus a part of the surface having a high temperature, e.g. 90° C., will result in a more or less constant light-emission from the part of the light-emitting electrochemical cell 4 that covers that part of the surface 13 while another part of the surface 13 having a lower temperature, e.g. 60° C., will result in a flashing light-emission from the part of light-emitting electrochemical cell 4 that covers that part of the surface 13. Thus the user of the appliance will visually see what parts of the surface 13 that have the highest temperatures and which parts that have a lower temperature. Thereby the additional advantage of indicating the presence of local hot spots on a surface is provided by the light-emitting electrochemical cell 4.

As is shown in FIG. 1 it is possible to provide the temperature indicator with an AC voltage frequency modulator 7. With such a modulator 7 it is possible for the end user to set, within certain limits, the temperature at which light emission should start.

When forming the above described temperature indicator 1 a light-emitting electrochemical cell is first formed by sandwiching the light-emitting layer, comprising the matrix with the ions included therein, between the two electrodes. The light-emitting electrochemical cell in itself could be manufactured according to per se known techniques, such as is described in U.S. Pat. No. 5,682,043, of coating a solution of polymeric substances and salt on a first electrode, curing the polymer to form a light-emitting layer on the first electrode and subsequently depositing a second electrode onto the light-emitting layer. According to the present invention the two electrodes are then connected to an AC power source and finally the frequency of the AC power source is tuned in such way that light emission starts when the light-emitting electrochemical cell is heated above a certain temperature.

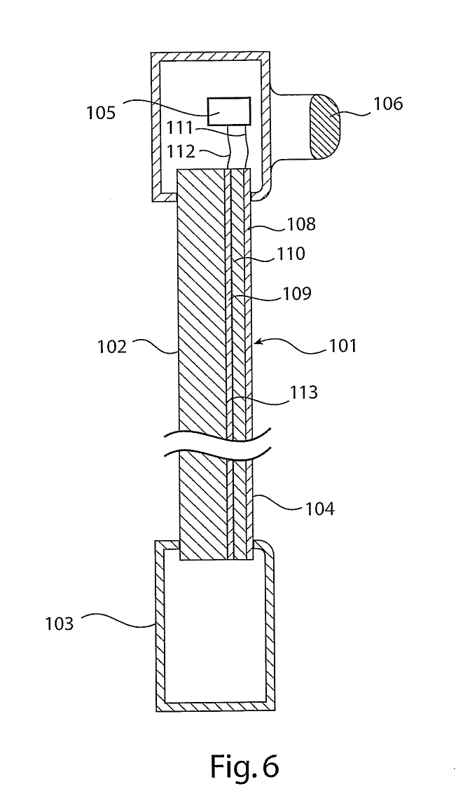

FIG. 6 is a cross section and illustrates, schematically, a temperature indicator 101 according to a second embodiment of the invention. This temperature indicator 101 is attached to the outer surface 113 of a window 102 of a household oven door 103 having, on the outside, a handle 106. The temperature indicator 101 comprises a light-emitting electrochemical cell 104, which has the form of a thin laminate, and an AC power source 105 adapted to drive the light-emitting electrochemical cell 104 with a low frequency AC voltage. The AC power source 105 is connected to the main electricity system (not shown in FIG. 1) of the oven. A preferred way of activating the power source 105 is to have it activated automatically as soon as the oven is activated and allow the power source 105 to remain activated for a certain time, e.g. 30 minutes, after the controls of the oven has been put to “0° C.”.

The light-emitting electrochemical cell 104 comprises a first electrode 108, a second electrode 109 and a light-emitting layer 110 sandwiched between the electrodes 108, 109. The AC power source 105 provides the two electrodes 108, 109 with voltage via a first contact 111 and a second contact 112 respectively.

Both the first electrode 108 and the second electrode 109 are made from an at least partly transparent electrode material, such as indium tin oxide (ITO). Other transparent electrode materials could be used as well. Also the light-emitting layer 110 is made from an at least partly transparent material, preferably a transparent polymeric material. The use of at least partly transparent materials all through the light-emitting electrochemical cell 104 makes it transparent all together and makes it possible for the user to see through the light-emitting electrochemical cell 104 and through the window 102 to observe what happens inside the oven.

When the oven window 102 gets hot it will transmit heat to the light-emitting electrochemical cell 104 which will, according to the set frequency of the AC power source 105, start to emit light at a threshold temperature to alert the user, and also small children and pets, that the oven window 102 is hot and should not be touched.

As alternative to making the light-emitting electrochemical cell 104 cover the whole window 102, as shown in FIG. 6, it is also possible to design a light-emitting electrochemical cell that covers only part of the oven window, e.g. a light-emitting electrochemical cell that forms a frame around the outer periphery of the window.

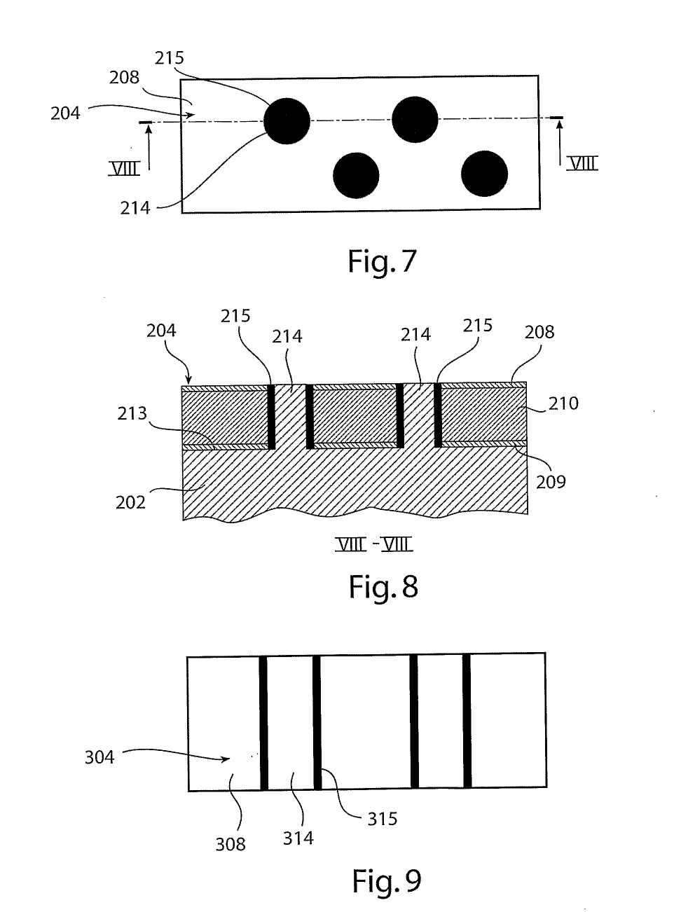

FIG. 7 is a top view and shows an alternative light-emitting electrochemical cell 204. The light-emitting electrochemical cell 204, which is shown in cross-section in FIG. 8, is rather similar to the cell 4 shown in FIG. 2 and thus the light-emitting electrochemical cell 204 has a first electrode 208, a second electrode 209 and a light-emitting layer 210 sandwiched between the electrodes 208, 209. The second electrode 209 is attached to a surface 213 of a sole 202 of an iron (not shown in FIG. 7). Cylindrical thermal contacts 214 extend from the sole 202 through the light-emitting electrochemical cell 204. The purpose of these contacts 214 is to improve the transfer of heat from the sole 202 to the garment that is to be ironed. Thus the contacts 214 decrease the insulating effect of the cell 204 and permits the use of a cell 204 with a higher thickness without deteriorating the function of the iron. The thermal contact 214 is electrically insulated from the light-emitting electrochemical cell 204 by means of a sleeve 215 made of an electrically insulating material, such as a non-conductive polymer.

FIG. 9 is a top view and indicates yet another alternative light-emitting electrochemical cell 304. The light-emitting electrochemical cell 304 is similar to the cell 204 shown in FIGS. 7 and 8 with the exception that the cell 304 is provided with bar shaped thermal contacts 314 extending through a first electrode 308, a light-emitting layer and a second electrode (the latter ones not being shown in FIG. 9) and being electrically insulated from the cell 304 by means of an isolating sleeve 315.

In the embodiments of FIGS. 7-9 thermal contacts are shown. As alternative a light-emitting electrochemical cell could be perforated for the reason of enabling a user to see through the light-emitting electrochemical cell. Such a cell could be used in the temperature indicator shown in FIG. 6 in order to make it easier to observe what happens inside an oven. The perforations in such a light-emitting electrochemical cell could be filled with glass beads through which a user could look into the oven.

It will be appreciated that numerous variants of the above-described embodiments are possible within the scope of the appended patent claims.

For example it is possible to design temperature indicators that start emitting light at different temperatures. In household appliances the main risk is that of human burn injuries. Thus the temperature indicator is preferably formed to start emitting light at a temperature of about 50-80° C., i.e. at temperatures at which there is a risk of burn injuries to humans and animals. In industrial applications the temperature at which light should start to be emitted could be judged by other limits, such as the need to avoid that water boils, in which case the temperature indicator is formed to start emitting light at temperatures just below 100° C.

The colour emitted by the temperature indicator could be chosen so as to fit with the actual demands. In an application where a warning for high temperatures is desired a red or orange light may be preferred. This could be obtained by choosing the material of the matrix and/or the ions such that red light is emitted. As an alternative the light-emitting layer and/or the electrodes could be mixed with a red dye such that an initially white or yellow light emitted is observed as a red light. It is of course also possible to use other colours, such as green and blue, depending on what message is to be given by the temperature indicator. Furthermore it is also possible to combine the light-emitting electrochemical cell with colour filters in order to obtain the desired colours.

Above it is described that the temperature indicator is applied in order to warn for high temperatures. The temperature indicator may of course also be used to indicate that a desired temperature has been reached. One example is a water cooker in which a temperature indicator could be tuned to start emitting light when a desired temperature, such as 100° C., has been reached. Combinations of several temperature indicators is also possible. One temperature indicator could be designed to provide an orange light when the temperature exceeds 60° C. to issue a warning that the water cooker is hot. A second temperature indicator could be designed to provide a green light when the temperature reaches 100° C. to indicate that the water is ready for use. A third temperature indicator could provide a red light when the temperature exceeds 100° C. indicating that the water cooker has run dry. The temperature indicator could also be designed to indicate which parts of the water cooker that are hot.

In order to provide the temperature indicator with electrical protection, mechanical scratch protection or protection against water it could be provided with a thin protective top coating, such as a thin polymer layer provided on the first electrode or even hermetically encapsulating the entire light-emitting electrochemical cell.

The frequency of the AC power source is adapted to fit the actual temperature level at which light emission should start and the actual light-emitting electrochemical cell. In most cases it has proven suitable with a frequency in the range of 0.5-10 Hz to provide a temperature indicator with sufficiently quick response and high visibility. However the usable frequency range may be extended to higher values, such as up to about 100 Hz, depending on the materials used, the geometry of the light-emitting electrochemical cell etc.

Above it is described how a temperature indicator according to the invention is attached to the sole of an iron or to the window of an oven door or a water cooker. Other examples of household appliances to which a temperature indicator could be attached include, but is not limited to, heat radiators, hot plates, hot water pipes, toasters, deep fryers and waffle irons.

To summarize a temperature indicator for indicating a high temperature at a surface comprises a light-emitting electrochemical cell having a first electrode, a second electrode and a light-emitting layer being sandwiched between the two electrodes. The light-emitting layer comprises a matrix and ions being movable in the matrix, the mobility of said ions in said matrix being temperature dependent. A power source is adapted for driving the light-emitting electrochemical cell with an AC voltage. The frequency of the AC voltage is tuned in such a way that, above a certain temperature level, the ions move fast enough in the matrix to provide a sufficient charge gradient in the light-emitting electrochemical cell for the light-emitting electrochemical cell to emit light before the AC power source shifts the polarity of the voltage.

1. A temperature indicator (1; 101) adapted to be provided on a surface (13; 113) for providing a visual indication of the temperature of the surface (13; 113), the temperature indicator (1; 101) comprising a light-emitting electrochemical cell (4; 104) having a first electrode (8; 108), a second electrode (9; 109) and a light-emitting layer (10; 110) being positioned between the two electrodes (8, 9; 108, 109) and comprising a matrix and ions being movable in the matrix, the mobility of said ions in said matrix being temperature dependent, the temperature indicator (1; 101) further comprising a power source (5; 105) adapted for driving the light-emitting electrochemical cell (4; 104) with an AC voltage, the frequency of which is tuned in such a way that the light-emitting electrochemical cell (4; 104) emits light when the temperature of the surface (13; 113) exceeds a certain level.

2. A temperature indicator according to claim 1, wherein the electrodes (8, 9; 108, 109) and the light-emitting layer (10; 110) form a thin laminate, at least one of the first electrode (8; 108) and the second electrode (109) being made from a transparent material such that the light emitted by the electrochemical cell (4; 104) may be transmitted through said at least one electrode (8; 108, 109).

3. A temperature indicator according to claim 2, wherein the first electrode (8; 108) is made from a transparent material and the second electrode (9; 109) is in contact with said surface (13; 113) such that heat is transmitted from the surface (13; 113) to the light-emitting layer (10; 110) through the second electrode (9; 109), the light emitted by the light-emitting electrochemical cell (4; 104) being transmitted through the first electrode (8; 108).

4. A temperature indicator according to claim 2, wherein both electrodes (108, 109) and the light-emitting layer (110) are substantially transparent.

5. A temperature indicator according to claim 1, wherein the matrix of the light-emitting layer (10; 110) comprises an organic material.

6. A temperature indicator according to claim 5, wherein the matrix of the light-emitting layer (10; 110) comprises a polymeric material.

7. A temperature indicator according to claim 1, wherein the temperature indicator (1) comprises an AC voltage frequency modulator (7) enabling the tuning of the surface temperature at which light emission is intended to start.

8. A temperature indicator according to claim 1 wherein the frequency of the AC voltage is tuned to make the electrochemical light-emitting cell (4; 104) start emitting light at a surface temperature in the range of 50-80° C.

9. A temperature indicator according to claim 1, wherein the total thickness (x) of the light emitting cell (4; 104) is less than 1 mm.

10. A temperature indicator according to claim 1, wherein the temperature indicator (1; 101) is adapted to cover substantially the entire potentially hot surface (13; 113) of an appliance (3; 103), the temperature indicator (1; 101) indicating which parts of said surface that are hot.

11. A temperature indicator according to claim 1, wherein the light-emitting electrochemical cell (204; 304) is provided with thermal contacts (214; 314), that extend through the light-emitting electrochemical cell (204; 304) and are adapted to conduct heat through said cell (204; 304).

12. A method of forming a temperature indicator (1; 101) adapted to be provided on a surface (13; 113) for providing a visual indication of the temperature of the surface (13; 113), comprising the steps of:
providing a light-emitting electrochemical cell (4; 104) having a first electrode (8; 108), a second electrode (9; 109) and a light-emitting layer (10; 110) being positioned between the two electrodes (8, 9; 108, 109) and comprising a matrix and ions being movable in the matrix, the mobility of said ions in said matrix being temperature dependent,
connecting an AC power source (5; 105) to the electrodes (8, 9; 108, 109) of the light-emitting cell (4; 104), and
tuning the frequency of the AC voltage such that the electrochemical cell (4; 104) emits light when heated above a certain temperature.

13. A household appliance having applied to a surface (13; 113) thereof a temperature indicator (1; 101) according to claim 1.
